(19) United States
(12) Patent Application Publication
(10) Pub. No.: US 2026/0049173 A1
(43) Pub. Date: Feb. 19, 2026

(54) EPOXY-ALCOHOL-BASED MULTI-COMPONENT RESIN SYSTEM

(71) Applicant: Hilti Aktiengesellschaft, Schaan (LI)

(72) Inventor: Nicole Behrens, Muenchen (DE)

(73) Assignee: Hilti Aktiengesellschaft, Schaan (LI)

(21) Appl. No.: 19/104,452

(22) PCT Filed: Aug. 2, 2023
(86) PCT No.: PCT/EP2023/071462

§ 371 Date: Feb. 18, 2025

(30) Foreign Application Priority Data
Aug. 29, 2022 (EP) 22192538.1

(51) Int. Cl. C08G 59/24; C04B 7/32; C08G 59/22; C08G 59/38; C08G 59/62; C08K 3/36; C08K 3/38

(52) U.S. Cl. CPC C08G 59/245; C04B 7/326; C08G 59/226; C08G 59/38; C08G 59/621; C08K 3/36; C08K 3/38; C08G 2150/00; C08G 2170/00; C08K 2003/387

(57) ABSTRACT

The present invention relates to a multi-component resin system comprising (i) at least one resin component (A) comprising at least one curable epoxy resin and (ii) at least one curing agent component (B) comprising at least one primary alcohol and copper (II) tetrafluoroborate. The present invention further relates to the use of such a multi-component resin system for the chemical fastening of construction elements in holes (for example boreholes) or gaps, and the use as an adhesive or as a coating.

The present invention relates to a multi-component resin system comprising (i) at least one resin component (A) comprising at least one curable epoxy resin and (ii) at least one curing agent component (B) comprising at least one primary alcohol and copper (II) tetrafluoroborate. The present invention further relates to the use of such a multi-component resin system for the chemical fastening of construction elements in holes (for example boreholes) or gaps, and to the use as an adhesive or as a coating.

In the construction industry, resin systems are used for the chemical fastening of construction elements, such as anchor rods, reinforcing bars and screws, in boreholes or gaps of buildings. Resin systems of this kind are also referred to as “chemical anchors.” Likewise, resin systems play an important role for use as an adhesive or a coating (e.g., for floor coverings).

These resin systems can be present as a unitary resin composition or as a system made up of a plurality components. Usually, resin systems are commercially available as a multi-component resin system. A multi-component resin system is understood to mean a resin system having a plurality of components, typically two components (two-component system), with (i) at least one resin component (A) and (ii) at least one curing agent component (B), and optionally further separate components. The components are in separate containers so that they do not come into contact with one another during storage and cannot react with one another before application. For the intended use of a multi-component resin system, the components (A) and (B), and in some cases further components, are mixed at the desired site of use so that the curing reaction can take place there.

For storage before use, cartridges are suitable which are, for example, made of plastic, ceramic or glass, in which cartridges the components are arranged separately from one another by destructible delimiting walls or integrated separate destructible containers, for example as cartridges nested in one another, preferably two-chamber cartridges, and in particular multi-component or preferably two-component cartridges, in the chambers of which the components (A) and (B) of a multi-component resin system are contained. By destroying the delimitations in the cartridges or discharging the cartridges by, for example, a static mixer, the two or more components are mixed. As a result, a curing reaction, i.e., polymerization, is initiated and the resin is cured.

In a multi-component resin system, other customary constituents, for example fillers, additives, accelerators, inhibitors, solvents and reactive diluents, can be contained in one or both components (A) and/or (B), and optionally further components. Multi-component resin systems may in some cases also contain fillers, which can contribute to solidification, even by hydraulic setting, as in the case of cement.

A widely used multi-component resin system is an epoxy-amine-based epoxy resin system (such as described, for example, in EP2826796 A1 and EP 3 626 756 A1). In such an epoxy resin system, the resin component (A) contains at least one curable epoxy resin, and the curing agent component (B) contains at least one amine which can cure the curable epoxy resin.

The amines contained in such epoxy-amine-based epoxy resin systems are frequently marked as “caustic” (GHS05), as a result of which problems arise for the user in handling and possibly the need for protective equipment and which makes it difficult to use on sensitive substrates which are attacked by the caustic effect of the amines. The amines contained usually originate from non-renewable, i.e., fossil sources. In contrast, commercially available epoxy resins already have a high proportion of renewable raw materials, because they can be produced, for example, from epichlorohydrin, which is in turn obtained from glycerol. Glycerol accumulates on a large scale as a by-product of biodiesel production. The epoxy resin can originate in part (via the synthesis with epichlorohydrin) or totally from renewable sources. Examples of epoxy resins from renewable sources are isosorbide diglycidyl ether (CAS 13374-44-2), limonene-1,2:8,9-dioxide (LDO, CAS 96-08-2), vanillin diglycidyl ether (DGEVA, CAS 1584677-14-4), phioroglycoinol triglycidyl ether (PTHE, CAS 4223-14-7), vanillic acid bisepoxid (CAS 1393710-63-8), and epoxidized vegetable oil, such as epoxidized castor oil (CAS 105839-17-6) and epoxidized cardanol oil (mixture comprising, inter alia, CAS 1260636-34-7 and CAS 63284-28-6). Examples of commercially available bio-based polyepoxides which can be used for epoxy-amine systems are Erisys GE 35-H (epoxidized castor oil, Huntsman, Belgium), Erisys GE 60 and GE 61 (multifunctional epoxide based on Sorbitol, Huntsman, Belgium) and Araldite DY-S(multifunctional epoxide based on polyglycerol, Huntsman, Belgium).

An object of the present invention is therefore to provide a more environmentally friendly epoxy resin system, in the curing agent component (B) of which the amine is replaced by another compound. Preferably, the amine is at least partially replaced by a compound which can be obtained from renewable raw materials. Another object is to provide an epoxy resin system for use on sensitive substrates which are attacked by the caustic action of the amines. The curing of the system should be possible in typical ambient and substrate temperatures of and in buildings, in particular at room temperature (25° C.), because many of the applications take place in the construction sector, where it is not possible to introduce heat.

The objects of the invention are achieved by providing a multi-component resin system according to claim 1. Preferred embodiments of a multi-component resin system according to the invention are provided in the dependent claims, which may be combined with one another unless otherwise indicated.

The invention relates to a multi-component resin system comprising at least one resin component (A) comprising at least one curable epoxy resin; and at least one curing agent component (B) comprising a curing agent for the epoxy resin contained in the resin component (A), wherein the curing agent is at least a primary alcohol having an average OH functionality of approximately 2 or higher; further comprising copper (II) tetrafluoroborate. The copper (II) tetrafluoroborate is typically copper (II) tetrafluoroborate in anhydrous form or copper (II) tetrafluoroborate hydrate.

The subject matter of the invention is also the use of an epoxy resin composition produced from a multi-component resin system according to the invention as an adhesive, as a coating, or as a chemical anchor. The subject matter is in particular the use as chemical anchors for chemical fastening of construction elements, in particular in (bore) holes or gaps, as well as adhesive or coating. The use typically takes place on or in a substrate, such as steel, wood, rock or bricks, which occurs in structures. This substrate is preferably non-basic, i.e., for example, preferably not concrete.

The present invention replaces the amine used as a curing agent in commercially available epoxy resin multi-component systems with a primary alcohol having an average OH functionality of approximately 2 or greater. Surprisingly, it has been found that the resulting epoxy resin alcohol multi-component system cures at 25° C. within an acceptable time to a polymer suitable for the respective uses when copper (II) tetrafluoroborate is used as accelerator.

It is therefore essential to the invention that a multi-component resin system according to the invention comprises copper (II) tetrafluoroborate; preferably that a multi-component resin system according to the invention comprises copper (II) tetrafluoroborate only in component (B). This is because copper (II) tetrafluoroborate in component (A) could lead to an at least partial homopolymerization of the at least one curable epoxy resin in component (A).

Copper (II) tetrafluoroborate is present with a molar fraction of approximately 0.1 to approximately 20 mol % based on the amount of substance of the at least one primary alcohol in component (B), preferably with a molar fraction of approximately 1 to approximately 17 mol %, based on the amount of substance of the at least one primary alcohol in component (B), more preferably with a molar fraction of approximately 2 to approximately 15 mol %, even more preferably with a molar fraction of approximately 2 to approximately 12 mol %, based on the amount of substance of the at least one primary alcohol in component (B).

Within the context of the invention, the terms used above and in the following description have the following meanings:
“Multi-component resin system” denotes a resin system that comprises a plurality of components stored separately from one another, wherein the resin system comprises a resin component (A) and at least one curing agent component (B), so that curing takes place only after all components have been mixed. In a preferred embodiment, a multi-component resin system is a two-component resin system.
“Epoxy resin composition” denotes a reactive composition comprising a curable epoxy resin and a suitable curing agent for the curable epoxy resin. According to the invention, this is typically obtained by mixing the resin component (A) and the curing agent component (B) and subsequently is used for chemical fastening, as an adhesive or as a coating.
“Curable epoxy resin” denotes a resin which contains reactive epoxide groups which can be reacted with a suitable curing agent to form a cured resin in a polymerization reaction, wherein an epoxide is a cyclic ether having a triatomic ring. Another term for epoxide group is glycidyl group.
“Mean epoxide functionality” describes the averaged number of reactive epoxide groups of one or a mixture of a plurality of curable epoxy resins per molecule.
“Alcohol” denotes an organic compound having at least one hydroxyl group (R—OH; here also referred to as OH group). It is between primary (R—CH₂—OH), secondary (R¹—CR²H—OH) and tertiary (R¹—CR²R³—OH) alcohols or OH groups: aromatic alcohols or OH groups (the hydroxyl group is linked directly to an aromatic), and mono- and polyhydric alcohols (with one or more hydroxyl groups). A primary alcohol can contain one or more primary OH groups, and it can also contain further, non-primary (i.e., for example, secondary) OH groups, in addition to the one or more primary OH groups.
“Mean OH functionality” describes the average number of OH groups (hydroxyl groups) in an alcohol or a mixture of alcohols which can react with an epoxide group. In the context of the present invention, the mean OH functionality only relates to primary OH groups, because these are the groups which can react with an epoxide group in the presence of copper (II) tetrafluoroborate. “Mean OH functionality” therefore describes, in the context of the present invention, the averaged number of primary OH groups (hydroxyl groups) in an alcohol or a mixture of alcohols. It is for a mixture according to the formula: mean OH functionality (mixture)=ΣOH functionality (alcohol i)/ni, i.e., the sum of the OH functionality (number of primary OH groups per molecule) of the individual alcohols i divided by the number of individual alcohols i. If only one alcohol or a mixture of alcohols having the same OH functionality is present, then the “mean OH functionality” corresponds to the OH functionality of the alcohol.
“Hydrate” denotes a chemical compound to which one or more water molecules are bound. In the case of crystalline solids, such as salts, the bound hydrate water is also called water of crystallization. The number of bound water molecules can vary. Typically, a number of water molecules in salts is in the range from 1 to 12. Copper (II) tetrafluoroborate crystallizes with an unknown number of molecules of water of crystallization; the only currently commercially available copper (II) tetrafluoroborate with a defined number of molecules of water of crystallization is copper (II) tetrafluoroborate hexahydrate.
“Non-basic substrate” denotes a substrate, in particular a build material, which generates an aqueous solution upon contact with water, which reacts with non-basic, i.e., neutral or acidic. A non-basic reaction is caused by a balanced ratio of hydronium cations and hydroxide anions, or the presence of an excess of hydronium cations in solution, wherein a pH≤7 is measured. As a counterexample, a basic substrate is concrete. Concrete is therefore preferably not a substrate when using the multi-component resin system according to the invention.
“Substrate temperature” denotes the temperature of the substrate on the contact surface for the epoxy resin composition to be cured. The substrate temperature is a function of the ambient temperature, in the construction industry, typically the outside temperature, as well as possible heating due to solar radiation and external heat supply by heat sources such as a heating block or a heating fan. The substrate temperature can be determined using an infrared thermometer.
“Aliphatic compounds” are acyclic or cyclic, saturated or unsaturated carbon compounds, excluding aromatic compounds;
“Cyclo-aliphatic compounds” are aliphatic compounds comprising or consisting of a carbocyclic ring structure, excluding benzene derivatives or other aromatic systems.
“Aromatic compounds” are compounds which follow Hückel's rule (4n+2).
“Araliphatic compounds” are compounds with an aliphatic and an aromatic substructure; in the case of a functionalized araliphatic compound, a functional group (for example a primary OH group) is bonded to the aliphatic part and not to the aromatic part of the compound.
“Heteroaromatic compounds” are compounds which further contain a heteroatom in the aromatic system.
“poly”, “Poly” as a prefix means that two or more of the groups adjoining this prefix are contained in a compound.
The article “a” or “an” preceding a class of chemical compounds, e.g., preceding the word “filler,” means that one or more compounds included in this class of chemical compounds, e.g., various “fillers,” may be meant.
“At least one” means numerically “one or more”; in a preferred embodiment, this term numerically means “one”.
“Approximately” before a numerical value allows a deviation of ±10%, in a preferred embodiment ±5%, in a highly preferred embodiment ±1% of this numerical value, in the most preferred embodiment “approximately” means exactly this numerical value, i.e., a deviation of ±0%.
“Contain” and “comprise” mean that more constituents may be present in addition to the aforementioned constituents; these terms are meant to be inclusive and therefore also include “consist of”; “consist of” is meant conclusively and means that no further constituents may be present; in a preferred embodiment, the terms “contain” and “comprise” mean the term “consist of”.

All standards cited in this text (e.g., DIN standards) were used in the version that was current on the filing date of this application. All trade names corresponding to the products available under these trade names at the time of filing the present application.

As stated above, a multi-component resin system according to the present invention is a system which comprises two or more components stored spatially separated from one another. In a preferred embodiment, a multi-component resin system according to the invention is a two-component resin system. In the following, the constituents of the components (A) and (B) of a multi-component resin system according to the invention are explained in more detail by way of example in reference to a two-component system.

Epoxy-alcohol systems according to the invention are multi-component systems in which an epoxide group of the curable epoxy resin contained in component (A) reacts in a calculated manner with a primary alcohol group of the alcohol contained in component (B). The mixing ratio of an epoxide and an alcohol is calculated from the epoxy-equivalent weight (EEW) and the molecular weight of the alcohol divided either by the number of primary alcohol groups per alcohol molecule (calculated AHEW) or by the previously experimentally determined experimental AHEW. In general, however, mixtures are used which contain, for example, a plurality of epoxides and/or alcohols and further substances, such as fillers. In this case, for example, the EEW of the mixture is calculated as follows:

$${EEW}_{mixture} = \frac{{weight}_{mixture} in g}{( \frac{{weight}_{raw materia11} in g}{{EEW}_{raw material 1} in \frac{g}{EQ}} + \frac{{weight}_{raw material 2} in g}{{EEW}_{raw material 2} in \frac{g}{EQ}} + … )}$$

The AHEWs of a mixture are calculated accordingly via the individual AHEWs of the individual alcohols, the weight of the alcohols and the total weight of the component (B).

In commercially available epoxy resins, the EEW is generally indicated by the manufacturers or is determined or calculated by known methods (such as the method shown above). The EEW value indicates the amount in g of resin which contains 1 mol of epoxide groups and has the unit g/EQ (i.e., g per molar equivalent).

The AHEW can also be determined experimentally. The experimental determination of the AHEW is described further below.

### Curable Epoxy Resin

The resin component (A) of a multi-component resin system according to the invention comprises at least one curable epoxy resin.

A multitude of compounds known to a person skilled in the art and commercially available for this purpose, on an individual basis or in any desired mixtures with one another, can be considered as the at least one curable epoxy resin in component (A) of the present invention.

An epoxy resin usable in accordance with the invention can be both saturated and unsaturated and aliphatic, cycloaliphatic, aromatic or heterocyclic (for example isosorbide diglycidyl ether) and also have hydroxyl groups. Furthermore, such substituents may be contained which do not cause any interfering side reactions under the mixing or reaction conditions according to the invention, for example alkyl or aryl substituents, ether groups and the like. Trimeric and tetrameric epoxides are also suitable within the scope of the invention. Epoxy resins are preferably present in liquid form and generally have an average molecular weight of MW≤2000 g/mol.

The curable epoxy resin preferably has a mean epoxide functionality of approximately 1.5 or greater, more preferably approximately 2 or greater, more preferably from approximately 2 to approximately 10, even more preferably from approximately 2 to approximately 3, most preferably of approximately 2.

Curable epoxy resin used in the present invention can have an epoxy equivalent weight (EEW) of from approximately 120 to approximately 2000 g/EQ, preferably from approximately 140 to approximately 400 g/EQ, in particular from approximately 155 to approximately 300 g/EQ, very particularly from 158 to 290 g/EQ. Particularly preferred are curable epoxy resins with the EEWs indicated in the embodiments.

Preferably, the at least one curable epoxy resin is a glycidyl ether derived from a polyhydric alcohol, in particular a polyhydric phenol, such as bisphenol and novolac. Examples of such suitable epoxy resins are compounds selected from the group of diglycidyl ethers on the basis of resorcin, hydroquinone, 2,2-bis-(4-hydroxyphenyl) propane (bisphenol A), isomeric mixtures of dihydroxyphenylmethane (bisphenol F), tetrabromobisphenol A, novolacs, 4.4′-dihydroxyphenylcyclohexane, and 4,4′-dihydroxy-3,3′-dimethyldiphenylpropane. Particularly preferred are curable epoxy resins selected from the group of the diglycidyl ethers based on bisphenol A and bisphenol F and mixtures thereof, for example the epoxy resins used in the embodiments.

A preferred example of a commercially available bisphenol F-based epoxy resin, comprising bisphenol F diglycidyl ether, is Araldite GY 282. An example of a commercially available bisphenol-A-based epoxy resin, comprising bisphenol A diglycidyl ether, is Araldite GY 240.

In a further preferred embodiment, the at least one curable epoxy resin is an epoxy resin produced from renewable sources. Such epoxy resins from renewable sources are, for example, isosorbide diglycidyl ether (CAS 13374-44-2), limonene-1,2:8,9-dioxide (LDO, CAS 96-08-2), vanillin diglycidyl ether (DGEVA, CAS 1584677-14-4), phloroglycinol triglycidyl ether (PTHE, CAS 4223-14-7), vanillic acid bisepoxide (CAS 1393710-63-8), and epoxidized vegetable oil, such as epoxidized castor oil (CAS 105839-17-6, commercially available as Erisys GE 35-H from Huntsman, Belgium) and epoxidized cardanol oil (mixture comprising, inter alia, CAS 1260636-34-7 and CAS 63284-28-6). In addition to Erisys GE 35-H, examples of bio-based polyepoxides commercially available in relatively large amounts which can be used within the scope of the invention are also Erisys GE 60 and GE 61 (epoxy resin based on Sorbitol, Huntsman, Belgium) and Araldite DY-S(epoxy resin based on polyglycerol, Huntsman, Belgium).

The proportion of the at least one curable epoxy resin in the resin component (A) is >0 to 100 wt. %, preferably from approximately 10 to approximately 70 wt. %, more preferably from approximately 30 to approximately 60 wt. %, and particularly preferably from approximately 40 to approximately 60 wt. %, based on the total weight of the resin component (A).

Primary Alcohol with a Mean OH Functionality of Approximately 2 or Greater

The curing agent component (B) of a multi-component resin system according to the invention comprises at least one primary alcohol having a mean OH functionality of approximately 2 or greater and copper (II) tetrafluoroborate in anhydrous form or as a hydrate.

The curing agent in component (B) of the present invention is a plurality of primary alcohols having a mean OH functionality of approximately 2 or greater, individually or in any desired mixtures with one another. A mean OH functionality of approximately 2 to approximately 4 is preferred, more preferably a mean OH functionality of approximately 2 to approximately 3.

A primary alcohol used according to the invention as a curing agent comprises at least one primary OH group, but preferably comprises at least two primary OH groups. Furthermore, the alcohol can be both saturated and unsaturated and aliphatic, cycloaliphatic, araliphatic, or heteroaraliphatic and can further comprise substituents which do not cause any disruptive side reactions under the mixing or reaction conditions, for example alkyl or aryl substituents, ether groups and the like. Furthermore, the primary alcohols can contain further secondary or tertiary OH groups.

The primary alcohol used according to the invention is preferably an aliphatic, cycloaliphatic or araliphatic alcohol.

An aliphatic alcohol preferably comprises 2 to 30, more preferably 2 to 20, even more preferably 2 to 10, particularly preferably 2 to 6, C atoms. The carbon chain of the aliphatic alcohol may be branched or unbranched; preferably it is unbranched.

Preferably, a cycloaliphatic alcohol comprises 6 to 30, more preferably 7 to 20, even more preferably 7 to 15, particularly preferably 8 to 12, C atoms. The cycloaliphatic alcohol comprises at least one aliphatic side chain on which a primary OH group is located, preferably at least two aliphatic side chains on which a primary OH group is located. The aliphatic side chain preferably comprises 1 to 10, more preferably 1 to 8, even more preferably 1 to 6 C atoms. The aliphatic side chains can be branched or unbranched; particularly preferably they are unbranched.

An araliphatic alcohol preferably comprises 6 to 30, more preferably 6 to 20, even more preferably 7 to 15, particularly preferably 8 to 12, C atoms. An araliphatic alcohol comprises at least one aliphatic side chain, wherein the aliphatic side chain comprises 1 to 10, more preferably 1 to 8, even more preferably 1 to 6 C atoms and particularly preferably 1 to 2 C atoms. The aliphatic side chains can be branched or unbranched; particularly preferably they are unbranched. Particularly suitable araliphatic alcohols comprise at least two aliphatic side chains which are positioned at different sites on the aromatic basic structure of the araliphatic alcohol and each comprise a primary OH group.

Examples of particularly suitable alcohols are glycerol (1,2,3-propanetriol, CAS no. 56-81-5), 1,3-benzenedimethanol (CAS no. 626-18-6), 1,3-cyclohexanediol (CAS no. 504-01-8), 2,6-bis(hydroxymethyl)-p-cresol (CAS no. 91-04-3), 4,8-bis(hydroxymethyl) tricyclo[5.2.1.02,6]decane (CAS no. 26896-48-0), 1,3-propanediol (1,3-PDO, CAS 504-63-2), 1,5-pentanediol (1,5-PDO, CAS 111-29-5), 1,4-butanediol (1,4-BDO, 110-63-4), dipentaerythritol, pentaerythritol, erythritol, polyether polyols (e.g., polytrimethylene glycol, polytetramethylene glycol), polyester polyols, xylitol, lactitol, isomalt, sorbitol, mannitol, ethylene glycol (1,2-ethanediol), lignin polyols, cellulose, fructose, polyols which have been obtained from unsaturated fatty acids by ozonolysis and hydrogenation, and mixtures thereof.

Preferred suitable alcohols are alcohols from renewable sources, such as glycerol, 1,3-PDO, 1.5-PDO and 1,4-BDO and sugar alcohols such as xylitol, lactitol, isomalt, sorbitol, mannitol lignin polyols, cellulose, fructose. From this group, glycerol, 1,3-PDO, 1,5-PDO and 1,4-BDO are particularly suitable.

A particularly highly preferred example of a suitable alcohol is glycerol, alone or in a mixture with another alcohol, in particular in a mixture with one or more of the alcohols which are used in mixtures with glycerol in the embodiments.

The proportion of the at least one primary alcohol in the curing agent component (B) is approximately 20 to approximately 90 wt. %, preferably approximately 30 to approximately 80 wt. %, more preferably approximately 40 to approximately 80 wt. %, and particularly preferably approximately 50 to approximately 70 wt. %, based on the total weight of the curing agent component (B).

### Copper (II) Tetrafluoroborate

The copper (II) tetrafluoroborate is required according to the invention in order to bring about curing in an acceptable time of the curable epoxy resin with the primary alcohol. It therefore acts as an accelerator. Copper (II) tetrafluoroborate hydrate (CAS no. 207121-39-9) with molecular formula Cu(BF₄)₂×H₂O is used. Copper (II) tetrafluoroborate hydrate crystallizes with an undetermined number of molecules of water of crystallization. Preferably, a number of 1 to 12 water molecules are present as hydrate water, more preferably 4 to 8 water molecules. In some embodiments, mixtures of hydrates are present. In one embodiment, copper (II) tetrafluoroborate hexahydrate (CAS no. 72259-10-0) is present with 6 water molecules as hydrate water. In one embodiment, anhydrous copper (II) tetrafluoroborate (CAS no. 38465-60-0) is used.

Typically, the molar fraction of copper (II) tetrafluoroborate in component (B) is from approximately 1 to approximately 20 mol % based on the amount of substance of the at least one primary alcohol (i.e., the total amount of all alcohols having at least one primary OH group in mol) in component (B). The molar fraction is preferably approximately 2 to approximately 15 mol % based on the amount of substance of the at least one primary alcohol in component (B). Even more preferably, the molar fraction is from approximately 2 to approximately 12 mol % based on the amount of substance of the at least one primary alcohol in component (B).

The molar fractions are calculated as known to a person skilled in the art, via the molar mass of the at least one primary alcohol used and the molar mass of the copper (II) tetrafluoroborate used.

The proportion of the copper (II) tetrafluoroborate used according to the invention depends on the curing time required for the use, the curing temperature, and on the at least one primary alcohol used and the curable epoxy resin used, and can be varied according to the respective use. Thus, the proportion of the copper (II) tetrafluoroborate used according to the invention can be reduced, for example, when the curing temperature is increased.

### Further Constituents of Components (A) and (B)

Both the resin component (A) and the curing agent component (B) and both components (A) and (B) typically comprise, in addition to the curable epoxy resin or the primary alcohol and the copper (II) tetrafluoroborate, at least one further constituent. Further customary constituents are in particular reactive diluents, fillers, adhesion promoters, rheological additives and thickeners (thixotropic agents).

Depending on the further constituent, it may be preferred that the at least one further constituent is contained only in the resin component (A), only in the curing agent component (B), or in both components.

### Reactive Diluent

In one embodiment, the resin component (A) and/or the curing agent component (B), preferably at least the resin component (A), can contain at least one reactive diluent. Glycidyl ethers of aliphatic, cycloaliphatic or aromatic monoalcohols or in particular polyalcohols, which have a lower molecular mass and viscosity than the curable epoxy resins described further above, are used as reactive diluents.

Examples of suitable reactive diluents are monoglycidyl ethers, e.g., o-cresyl glycidyl ether, and glycidyl ethers having an epoxide functionality of at least 2, such as 1,4-butanediol diglycidyl ether (BDDGE), cyclohexanedimethanol diglycidyl ether and hexanediol diglycidyl ether (HDDGE), as well as tri- or higher glycidyl ethers, such as glycerol triglycidyl ether, pentaerythritol tetraglycidyl ether, trimethylolpropane triglycidyl ether (TMPTGE), or trimethylolethane triglycidyl ether (TMETGE), with BDDGE, HDDGE, trimethylolpropan triglycidyl ether and trimethylolethane triglycidyl ether being preferred. Mixtures of two or more of these reactive diluents can also be used, preferably mixtures containing triglycidyl ethers, particularly preferably as a mixture of 1,4-butanediol diglycidyl ether (BDDGE) and trimethylolpropane triglycidyl ether (TMPTGE) or 1,4-butanediol diglycidyl ether (BDDGE) and trimethylolethane triglycidyl ether (TMETGE).

The reactive diluents used in the examples and the mixtures thereof used therein are particularly preferred.

The at least one reactive diluent, when present, is preferably in a proportion of >0 to approximately 30 wt. %, based on the total weight of the component in which the reactive diluent is contained (for example the resin component (A), in particular in a proportion of approximately 10 to approximately 25 wt. %, based on the total weight of the component.

### Fillers

Both the resin component (A) and the curing agent component (B) can contain at least one filler. It is preferable for both the resin component (A) and the curing agent component (B) to each contain at least one filler.

Fillers used are preferably inorganic fillers, in particular quartz, aluminum oxides, glass, corundum, porcelain, stoneware, barite, Leichtspat, gypsum, talcum, and/or chalk, and mixtures thereof. The at least one filler is preferably a non-basic filler. In particular, the at least one filler is not cement. According to the invention, basic fillers such as cements (e.g., Portland cement or aluminate cement) are typically dispensed with, because they can slow down or prevent curing of the epoxy resin composition after the components (A) and (B) of a multi-component resin system according to the invention are mixed.

The fillers can be added in the form of particles (for example in the form of powders, sands, or flours) or molded bodies (the latter preferably in the form of fibers or balls). A suitable selection of the fillers with regard to type and particle size distribution, particle size or (fiber) length can be used to control properties relevant to the application, such as rheological behavior, press-out forces, internal strength, tensile strength, pull-out forces, and impact strength.

Particularly suitable fillers are quartz powders, fine quartz powders, and ultra-fine quartz powders that have not been surface-treated, such as Millisil W3, Millisil W6. Millisil W8 and Millisil W12, preferably Millisil W12. Silanized quartz powders, fine quartz powders, and ultra-fine quartz powders can also be used. These are commercially available, for example, from the Silbond product series from the company Quarzwerke. The product series Silbond EST (modified with epoxysilane) and Silbond AST 25 (treated with aminosilane) are particularly preferred. Furthermore, it is possible for fillers based on aluminum oxide such as ultra-fine aluminum oxide fillers of the ASFP type from the company Denka, Japan (d₅₀=0.3 μm) or grades such as DAW or DAM with the type designations 45 (d₅₀<0.44 μm). 07 (d₅₀>8.4 μm), 05 (d₅₀<5.5 μm), and 03 (d₆₀<4.1 μm) to be used. Moreover, the surface-treated fine and ultra-fine fillers of the Aktisil AM 30 type (treated with aminosilane, d₅₀=2.2 μm) and Aktisil EM (treated with epoxysilane, d₅₀=2.2 μm) from Hoffman Mineral can be used. The fillers can be used individually or in any mixture with one another. Particularly preferred is quartz powder that has not been surface-treated, in particular Millisil W12.

When at least one filler is present, the total filling level of an epoxy resin composition made up of components (A) and (B) is in a range from >0 to approximately 60 wt. %, preferably in a range from approximately 10 to approximately 50 wt. %, more preferably in a range from approximately 15 to approximately 35 wt. %. The total filling level of the epoxy resin composition relates to the percentage by weight of filler based on the total weight of component (A) and component (B).

The proportion of fillers in the resin component (A) is preferably from approximately 1 to approximately 60 wt. %, more preferably from approximately 15 to approximately 50 wt. %, based on the total weight of the resin component (A). The proportion of fillers in the curing agent component (B) is preferably from approximately 1 to approximately 50 wt. %, more preferably from approximately 5 to approximately 40 wt. %, based on the total weight of the curing agent component (B).

### Thickeners and Further Optional Constituents

In one embodiment, the resin component (A), the curing agent component (B) or both components can contain at least one thickener.

Suitable thickeners are optionally organically post-treated fumed silica, bentonites, alkyl and methyl celluloses and castor oil derivatives, or mixtures of two or more thereof. Particular preference is given to organically post-treated fumed silica.

In a preferred embodiment, component (A) and/or component (B) of a multi-component resin system according to the invention comprises quartz powder and silica.

Furthermore, adhesion promoters for improving the crosslinking of a substrate (for example a (bore) hole wall) can be used with an epoxy resin composition produced from a multi-component resin system. Suitable adhesion promoters are silanes that have at least one Si-bound hydrolyzable group.

Preferred examples are 3-glycidoxypropyltrimethoxysilane, 3-glycidoxypropyltriethoxysilane, 2-(3,4-epoxycyclohexyl)ethyltrimethoxysilane, N-2-(aminoethyl)-3-aminopropylmethyldiethoxysilane, N-2-(aminoethyl)-3-aminopropyltriethoxysilane, 3-aminopropyltrimethoxysilane, 3-aminopropyltriethoxysilane, N-phenyl-3-aminoethyl-3-aminopropyltrimethoxysilane, 3-mercaptopropyltrimethoxysilane and 3-mercaptopropylmethyldimethoxysilane and trimethoxysilylpropyl diethyl tetramine and mixtures thereof. Further silanes are described, for example, in EP 3 000 792 A1.

Further optional constituents are rheological additives for adjusting the flow properties. Suitable rheological additives are: phyllosilicates such as laponites, bentonites or montmorillonite, Neuburg siliceous earth, fumed silica, polysaccharides; polyacrylate, polyurethane or polyurea thickeners and cellulose esters.

Wetting agents and dispersants, phlegmatizers, surface additives, plasticizers such as phthalic acid or sebacate esters, wax additives, stabilizers, antistatic agents, flexibilizers, curing catalysts, further control agents for the reaction rate, defoamers & deaerators, viscosity reducers or other process additives can also be added for optimization.

Likewise conceivable are coloring additives such as dyes or pigments, for example for different coloring of the components for better control of their mixing.

### Mixing Ratios of Components (A) and (B):

Components (A) and (B) are preferably mixed in such a ratio that the EEW and the alcohol-hydrogen equivalent weight (AHEW) values result in a balanced stoichiometry of reactive epoxide groups and primary alcohol groups.

As already mentioned above, the EEW in commercially available epoxy resins is generally indicated by the manufacturers or is determined or calculated by known methods. The EEW value indicates the amount in g of resin which contains 1 mol of epoxide groups and has the unit g/EQ (i.e., g per molar equivalent).

The AHEW is determined mathematically, or experimentally in a manner known to a person skilled in the art on the basis of the alcohol used. The AHEW value denotes the amount in g of alcohol which contains 1 mol of primary OH groups and has the unit g/EQ (i.e., g per molar equivalent).

The computational AHEW value can be determined mathematically as described above.

The experimental AHEW value can be obtained experimentally by determining the glass transition temperature (Tg) of a mixture comprising an epoxy resin (with known EEW) and one or more alcohols. In this case, the glass transition temperatures of epoxy resin/alcohol mixtures are determined with different ratios. The sample is cooled here at a heating rate of −10 K/min from 20 to −50° C., heated in a first heating cycle to 180° C. (heating rate 10 K/min), then re-cooled to −50° C. (heating rate −10 K/min) and heated (20 K/min) to 180° C. in the last step. The mixture having the highest glass transition temperature in the second heating cycle (“Tg2”) has the optimum ratio of epoxy resin and alcohol. The AHEW value can be calculated from the known EEW and the optimum epoxy resin/alcohol ratio as follows.

Example: EEW=158 g/EQ

Mixture of alcohol/epoxy resin with maximum Tg2:1 g alcohol with 4.65 g epoxy resin AHEW (alcohol)=1 g*158 g/EQ: 4.65 g=33.9785 g/EQ

### Use

During use, the resin component (A) and the curing agent component (B) are mixed in a suitable device, for example a static mixer or a dissolver, resulting in an epoxy resin composition.

When used as a “chemical anchor” for chemical fastening, the mixture is done directly in front of or in a hole (preferably a borehole) or gap, and the epoxy resin composition is then introduced into the (if necessary, previously cleaned) hole or the gap by means of a known injection device. Subsequently, the component to be fixed is inserted and adjusted into the epoxy resin composition, which is preferably a mortar composition here. The composition then cures.

When used as an adhesive or coating, the epoxy resin composition is mixed in a suitable manner (static mixer, manual stirring) and then applied to the parts to be bonded or to the substrate to be coated. Optionally, the composition may be heated for curing.

The reactive constituents of the curing agent component (B) react with the epoxy resins of the resin component (A), so that the epoxy resin composition cures under ambient conditions, for example at the construction site, within a desired time. This chemical reaction depends on the temperature, the moisture in the surroundings and the substrate, the chemical composition of the substrate, and on the constituents used of components (A) and (B). Environmental conditions can vary, for example low temperatures (e.g., −5° C.) or high temperatures (e.g., 40° C.) during the night-day cycles. At high ambient temperatures, the substrate can heat up, wherein substrate temperatures of above 30° C.; even above 40° C., and even approximately 100° C. or more are possible.

A multi-component resin system according to the invention is preferably used for construction purposes. The term “for construction purposes” means the construction bonding and the coating, and the use of the multi-component resin system as a chemical anchor. The substrates to which the multi-component system is applied are preferably non-basic.

The use takes place in particular on or in bricks, rock, steel or wood.

The use as an adhesive (in the case of construction bonding) is carried out in particular for bonding the combinations of brick/brick, brick/steel, wood/wood, wood/steel, steel/steel or any of the aforementioned materials on other mineral-based materials (which are preferably non-basic), for which the structural reinforcement of components made of wood, masonry and other mineral-based materials (which are preferably non-basic), for the reinforcement of building objects with fiber-reinforced polymers, for chemical fastening on surfaces made of brick, stone, wood, steel or other mineral materials (which are preferably non-basic).

The use as chemical anchors takes place in particular for the chemical fastening of construction elements and anchoring means, such as anchor rods, anchor bolts, (threaded) rods, (threaded) sleeves, reinforcement bars, screws and the like, into (bore) holes or gaps in different substrates, such as masonry, other mineral materials (which are preferably non-basic), metals (e.g., steel), ceramics, plastics, glass and wood. The substrates are preferably non-basic. In particular, the substrate is preferably not concrete or cement.

A multi-component resin system according to the invention is very particularly preferably used for the chemical fastening of anchoring elements in a hole (in particular a borehole) or gap in a building substrate.

The use is typically carried out at a substrate temperature of approximately −10° C. to approximately 180° C. The use as chemical anchors is typically carried out at a substrate temperature of approximately −10° C. to approximately 180° C., preferably from approximately 0° C. to approximately 120° C., more preferably from approximately 10° C. to approximately 60° C., even more preferably from approximately 20° C. to approximately 40° C., particularly preferably at a substrate temperature of approximately 25° C. By contrast, the use as an adhesive can preferably also take place at temperatures of approximately 20° C. to approximately 180° C., more preferably at temperatures of approximately 50° C. to approximately 150° C., even more preferably from approximately 80° C. to approximately 120° C. As a result of a higher temperature, more rapid curing is achieved and/or less copper (II) tetrafluoroborate is required.

Substrate temperature of approximately 120° C. to approximately 180° C. are possible, in particular in the case of external heat supply, wherein external heat supply is particularly suitable for accelerating the fastening of small components in holes or gaps and in particular as means for accelerating the curing or for reducing the amount of copper (II) tetrafluoroborate required for curing.

For use as chemical anchors in the construction sector, in particular in the case of large components, the substrate temperature typically depends on the ambient temperature.

Moreover, the use as a chemical anchor typically takes place on a substrate, such as steel, wood, stone or brick, which occurs in structures. This substrate is preferably non-basic. In particular, the substrate is preferably not concrete or cement.

### PREFERRED EMBODIMENTS

### Component (A):

In a preferred embodiment, component (A) of a multi-component resin system according to the invention comprises bisphenol F diglycidyl ether, quartz powder and silica.

In another preferred embodiment, component (A) of a multi-component resin system according to the invention comprises bisphenol F diglycidyl ether and bisphenol A diglycidyl ether, as well as 1,4-butanediol diglycidyl ether, trimethylolpropane triglycidyl ether, quartz powder and silica.

In a particularly preferred embodiment, component (A) of a multi-component resin system according to the invention comprises from approximately 55 to approximately 65 wt. % of bisphenol F diglycidyl ether, and from approximately 35 to approximately 45 wt. % of quartz powder and from approximately 1 to approximately 3 wt. % of silica, based on the total weight of component (A).

In another particularly preferred embodiment, component (A) of a multi-component resin system according to the invention comprises from approximately 35 to approximately 45 wt. % of bisphenol F diglycidyl ether, from approximately 15 to approximately 25 wt. % of bisphenol A diglycidyl ether, and from approximately 5 to approximately 10 wt. % of 1,4-butanediol diglycidyl ether, from approximately 5 to approximately 10 wt. % of trimethylolpropane triglycidyl ether, from approximately 35 to approximately 45 wt. % of quartz powder and from approximately 1 to approximately 3 wt. % of silica, based on the total weight of component (A).

### Component (B):

In a preferred embodiment, component (B) of a multi-component resin system according to the invention comprises 1,2,3-propanetriol and copper (II) tetrafluoroborate hydrate.

In a highly preferred embodiment, component (B) of a multi-component resin system according to the invention comprises from approximately 40 to approximately 65 wt. % of 1,2,3-propanetriol and from approximately 5 to approximately 25 wt. % of copper (II) tetrafluoroborate hydrate, based on the total weight of component (B).

In an even more preferred embodiment, component (B) of a multi-component resin system according to the invention comprises from approximately 40 to approximately 65 wt. % of 1,2,3-propanetriol and from approximately 5 to approximately 25 wt. % of copper (II) tetrafluoroborate hydrate, from approximately 10 to approximately 40 wt. % of quartz powder and from approximately 1 to approximately 3 wt. % of silica, based on the total weight of component (B).

In a further highly preferred embodiment, component (B) of a multi-component resin system according to the invention comprises from approximately 40 to approximately 65 wt. % of 1,2,3-propanetriol, from approximately 30 to approximately 40 wt. % of a further primary alcohol having an OH functionality of from approximately 2 or greater, and from approximately 5 to approximately 25 wt. % of copper (II) tetrafluoroborate hydrate, based on the total weight of component (B).

In an even more preferred embodiment, component (B) of a multi-component resin system according to the invention comprises from approximately 40 to approximately 65 wt. % of 1,2,3-propanetriol, from approximately 30 to approximately 40 wt. % of a further primary alcohol having an OH functionality of approximately 2 or greater, and from approximately 5 to approximately 25 wt. % of copper (II) tetrafluoroborate hydrate, from approximately 10 to approximately 40 wt. % of quartz powder and from approximately 1 to approximately 3 wt. % of silica, based on the total weight of component (B).

### Components A+B

Very particularly preferable as constituents of a multi-component resin system according to the invention are the combinations of the epoxy resins and the primary alcohols which are used in the example compositions, in particular in the weight fractions used there and very particularly preferably in combination with the other constituents of components (A) and (B) used there. Most preferred are those compositions of components (A) and (B) which are described in the examples.

In a particularly preferred embodiment of a multi-component resin system according to the invention, component (A) comprises from approximately 55 to approximately 65 wt. % of bisphenol F diglycidyl ether, and from approximately 35 to approximately 45 wt. % of quartz powder and from approximately 1 to approximately 3 wt. % of silica based on the total weight of component (A); and component (B) from approximately 40 to approximately 65 wt. % of 1,2,3-propanetriol, from approximately 5 to approximately 25 wt. % of copper (II) tetrafluoroborate hydrate, from approximately 10 to approximately 40 wt. % of quartz powder and from approximately 1 to approximately 3 wt. % of silica, based on the total weight of component (B).

In another particularly preferred embodiment of a multi-component resin system according to the invention, component (A) comprises from approximately 35 to approximately 45 wt. % of bisphenol F diglycidyl ether, from approximately 15 to approximately 25 wt. % of bisphenol A diglycidyl ether, and from approximately 5 to approximately 10 wt. % of 1,4-butanediol diglycidyl ether and from approximately 5 to approximately 10 wt. % of trimethylolpropane triglycidyl ether, from approximately 35 to approximately 45 wt. % of quartz powder and from approximately 1 to approximately 3 wt. % of silica, based on the total weight of component (A); and component (B) from approximately 40 to approximately 65 wt. % of 1,2,3-propanetriol, from approximately 5 to approximately 25 wt. % of copper (II) tetrafluoroborate hydrate, from approximately 10 to approximately 40 wt. % of quartz powder and from approximately 1 to approximately 3 wt. % of silica, based on the total weight of component (B).

The invention is described in greater detail below in reference to embodiments which, however, should not be understood in a restrictive sense.

### EMBODIMENTS

### Production of Components (A) and (B)

The constituents used of components A and B are listed in Table 2.

TABLE 2
constituents used

| Constituent | Function | Trade name or CAS | Manufacturer | Country |
|---|---|---|---|---|
| Bisphenol F-based epoxy resin | Epoxy resin | Araldite ® GY 282 | Huntsman | Belgium |
| Bisphenol A-based epoxy resin | Epoxy resin | Araldite ® GY 240 | Huntsman | Belgium |
| 1,4-Butanediol diglycidyl ether | Reactive diluent | Araldite ® DY-026 | Huntsman | Belgium |
| Trimethylolpropane triglycidyl ether | Reactive diluent | Araldite ® DY-T | Huntsman | Belgium |
| Copper(II) tetrafluoroborate hydrate | Accelerator | Copper(II) | Sigma-Aldrich | Germany |
| | | tetrafluoroborate | | |
| | | hydrate | | |
| 1,2,3-propanetriol | Alcoholic curing agent | Glycerol | Merck | Germany |
| 1,3-Benzenedimethanol | Alcoholic curing agent | 626-18-6 | Sigma-Aldrich | Germany |
| 2,6-Bis(hydroxymethyl)-p-cresol | Alcoholic curing agent | 91-04-3 | Sigma-Aldrich | Germany |
| 4,8-Bis(hydroxymethyl)tricyclo[5.2.1.0 ^{2, 6}]decane | Alcoholic curing agent | 26896-48-0 | Sigma-Aldrich | Germany |
| Quartz powder | Filler | Millisil ® W12 | Quarzwerke | Germany |
| | | | Frechen | |
| Cement | Filler | SupraCem 45 | Schretter & | Austria |
| | | | Cie GmbH & | |
| | | | Co KG | |
| Silica | Thickener | Cab-O-Sil ® TS-720 | Cabot | Germany |
| | | | Rheinfelden | |

The fractions of the individual constituents in the components (A) and (B) in Examples A1-A5, B1-B3 and C1-C4 are each indicated further below in Tables 3, 7 and 9 in percent by weight (wt. %).

To produce the resin component (A), the liquid constituents thereof were first mixed. Quartz powder and silica were then added and stirred in a dissolver (PC laboratory system, volume 1 liter) under vacuum at 3500 rpm for 10 min.

To produce the curing agent component (B), the alcohols contained therein were mixed. Subsequently, copper (II) tetrafluoroborate hydrate was added and dissolved in the resulting mixture. Thereafter, the quartz powder and the silica were added and stirred in a dissolver (PC laboratory system, volume 1 liter) under vacuum at 3500 rpm for 10 min.

### Preparation for the Use of Components (A) and (B)

For use as chemical anchors, as an adhesive or as a coating, components (A) and (B) were mixed with one another shortly before their use with the aid of a SpeedMixer (Hauschild, Hamm) for 30 sec, and the mixture obtained was filled immediately thereafter into a 1-component cartridge. The mixing ratio was chosen such that a balanced stoichiometry of EEW and AHEW as described above was produced. The 1-component cartridge was injected through a nozzle at the desired place of use.

### Measurement Methods for Characterizing the Multi-Component Resin Systems

To characterize a multi-component resin system, after mixing of its components (A) and (B), the gel time, Shore A hardness, Shore D hardness, tensile shear strength and/or glass transition temperature of the resulting mixture were analyzed. These parameters are characteristic variables for determining the suitability of a multi-component resin system for the use according to the invention as a chemical anchor, coating and/or adhesive.

### Determination of the Gel Time

20 ml of an epoxy resin composition were produced from components (A) and (B), and they were mixed in a SpeedMixer for 30 s. The mixing ratio was selected such that a balanced stoichiometry of EEW and AHEW was produced. Immediately after mixing, the temperature in the silicone bath was set to 25° C., and the temperature of the sample was measured. The gel time was determined using a commercially available device (GELNORM®-gel timer) at a temperature of 25° C. The sample itself is located in a test tube, which is placed in an air jacket, which is submerged in the silicone bath, for temperature control. The heat generation of the sample is plotted over time. The evaluation is carried out in accordance with DIN 16945. The maximum temperature reached (Tₘₐₓ) and the time after which the temperature maximum was reached (=gel time, t_{Tmax}) was determined.

### Determination of Shore a and Shore D Hardness

With the aid of the 1-component cartridge, the epoxy resin composition produced as described above (under “preparation”), consisting of the components (A) and (B), was dispensed from the 1-component cartridge into an aluminum crucible for use as a coating, spread out to form a 0.4 cm thin layer and then cured at 25° C. The Shore hardness was determined according to the standard ASTM D2240.

The Shore A hardness of the 0.4 cm thin layer of the curing epoxy resin composition was measured with the HBD 100-0 hardness tester from Sauter GmbH 4.5 h or 6.5 h (see further below) after the spreading operation.

The Shore D hardness of the 0.4 cm thin layer of the cured epoxy composition was measured with the HBD 100-0 hardness tester from Sauter GmbH 24 h after the spreading operation.

### Pull-Out Tests

For pull-out tests from wood, the procedure was performed in accordance with EAD 130006-00-0304 as follows:

Boreholes (diameter as indicated below in the individual examples, borehole depth 122 mm) were first drilled into a horizontal test body made of GLT (glue-laminated timber, spruce wood) with a hammer drill. The boreholes were cleaned (2× blown out with 6 bar compressed air). Subsequently, the boreholes were filled to two thirds full from the bottom of the borehole with the respective curable epoxy resin composition to be tested, which was produced as described above (under “preparation”) from the respective components (A) and (B), using the 1-component cartridge. For each borehole, a steel threaded rod (diameter as indicated below in the examples) was pressed in manually (embedding depth as indicated in the respective example). The excess epoxy resin composition was removed by means of a spatula. The curing took place at 25° C. After the time specified for the respective test, the threaded rod was pulled out until failure under measurement of the failure load. A brace with a diameter of 26 mm was used for the pull-out tests.

For pull-out tests from brick, the procedure, in accordance with EAD 330076-00-0604, was as follows:

First, boreholes (diameter as indicated in the examples, borehole depth approximately 87 mm) were drilled in a horizontal solid brick (supplier: Rais Ziegel Schmid, Schwabmünchen, Germany; dimensions: 240×113×113 mm; compressive strength: 21.8 N/mm²; gross bulk density 1.8 kg/dm³) with a hammer drill. The boreholes were cleaned (2× blowing out (compressed air) 6 bar, 2× brushing, 2× blowing out (compressed air 6 bar)). Sieve sleeves (type indicated in respective examples) were inserted into the cleaned boreholes. Subsequently, the sieve sleeves were filled to two thirds full from the bottom with the respective curable epoxy resin composition to be tested, which was produced as described above (under “preparation”) from the respective components (A) and (B), using the 1-component cartridge. For each borehole, a steel threaded rod (diameter as indicated below in the examples) was pressed in manually (embedding depth as indicated in the example). The excess mortar was removed using a spatula. After curing at 25° C. for the time indicated in the respective example, the threaded rod was pulled until failure under measurement of the failure load.

For pull-out tests from concrete, the procedure was performed in accordance with EAD 330499-00-0601 as follows:

Firstly, boreholes (diameter 14 mm; borehole depth 62 mm) were drilled in a horizontal concrete test piece (strength class C20/C25) using a hammer drill. The boreholes are cleaned (2× blowing out (compressed air) 6 bar, 2× brushing, 2× blowing out (compressed air 6 bar)). Subsequently, the boreholes were filled to two thirds full from the bottom of the bore with the curable epoxy resin composition, which was produced as described above (under “preparation”) from the respective components (A) and (B). using the 1-component cartridge. For each borehole, a steel threaded rod (diameter as indicated below in the examples) was pressed in manually (embedding depth as indicated in the example). The excess mortar was removed using a spatula. After curing at 25° C. for the time indicated in the respective example, the threaded rod was pulled until failure under measurement of the failure load.

### Determination of Tensile Shear Strength

The epoxy resin composition produced as described above (under “preparation”) from the respective components (A) and (B) was applied using the 1-component cartridge on a steel plate over an area of 12×25 mm in a layer thickness of 2 mm, and then a second steel plate was pressed on manually. Curing was carried out for 1 or 2 h at 100° C. Subsequently, the tensile shear strength was determined according to EN 1465:2009-07 at a test speed of 10 mm/min.

### Determination of the Glass Transition Temperature

To determine the glass transition temperature, the epoxy resin composition obtained by mixing in the SpeedMixer (30 sec), consisting of the components (A) and (B) of the multi-component resin system, was cured at 25° C. for 24 h. The sample was spread out for curing with a layer thickness of 1 mm and cured in this layer thickness. For the measurement, an amount of approximately 15 mg of the sample thus cured was used. The glass transition temperature was determined using the differential scanning calorimetry (DSC) method (STARe system DSC from Mettler Toledo). The sample was cooled at a heating rate of −10 K/min from 20° C. to −50° C. and held there for 5 min before the sample was then heated to 180° C. in a first heating run (heating rate 10 K/min), held there for 5 min, then cooled again to −50° C. (heating rate −10 K/min), held there for 5 min and heated again to 180° C. in the last step (20 K/min). “Tg1” was determined graphically in the first and “Tg2” in the second heating run.

### Examples A1-A5

The multi-component resin systems of the (comparison) Examples A1-A5 according to Table 3 were tested.

TABLE 3
Examples A1-A5

| | | Examples (parts by weight in wt. %) | | | | |
|---|---|---|---|---|---|---|
| Constituents | Function | A1* | A2 | A3 | A4 | A5 |

Component (A)

| | | | | | | |
|---|---|---|---|---|---|---|
| Bisphenol F-based | Epoxy resin | 58.0 | 58.0 | 58.0 | 58.0 | 58.0 |
| epoxy resin | | | | | | |
| Quartz powder | Filler | 40.7 | 40.7 | 40.7 | 40.7 | 40.7 |
| Silica | Thickener | 1.3 | 1.3 | 1.3 | 1.3 | 1.3 |

Component (B)

| | | | | | | |
|---|---|---|---|---|---|---|
| 1,2,3-propanetriol | Alcoholic | 63.0 | 63.0 | 63.0 | 63.0 | 63.0 |
| | curing agent | | | | | |
| Copper(II) | Accelerator | 0.0 | 10.0 | 15.0 | 20.0 | 25.0 |
| tetrafluoroborate | | | | | | |
| hydrate | | | | | | |
| Quartz powder | Filler | 34.6 | 24.6 | 19.6 | 14.6 | 9.6 |
| Silica | Thickener | 2.4 | 2.4 | 2.4 | 2.4 | 2.4 |

*Comparison example
EEW = 290 g/EQ (manufacturer specifications), AHEW = 73 g/EQ (calculated as described above)

Example A1 is a comparison example not according to the invention in which the copper (II) tetrafluoroborate hydrate is absent.

Results A1-A5 for Gel Time t_{Tmax} and Temperature Maximum Tₘₐₓ

The test results of the (comparison) Examples A1-A5 in Table 4 show that the use of the copper (II) tetrafluoroborate hydrate in component (B) enables curing of the epoxy resin composition after the mixing of components (A) and (B), while in the absence of copper (II) tetrafluoroborate hydrate in comparison example A1 no curing reaction takes place. In this case, a proportion of 10 wt. % of copper (II) tetrafluoroborate hydrate in component (B) in Example A2 leads initially to slow curing without any discernible temperature rise. With increasing weight fraction of copper (II) tetrafluoroborate hydrate in component (B), the gel time t_{Tmax} is shorter, which can be followed by faster curing. At the same time, the maximum temperature Tₘₐₓ reached also increases because the exothermic curing reaction releases the heat of reaction in a shorter time. Thus, the curing time can be controlled by the amount of copper (II) tetrafluoroborate hydrate used.

TABLE 4
Gel time t_{Tmax} and Tₘₐₓ determined for Examples A1 to A5

| | A1 | A2 | A3 | | A4 | | A5 | |
|---|---|---|---|---|---|---|---|---|
| t_{Tmax} | no curing | Slow curing (>1 h) | 37.9 | min | 19.1 | min | 11.0 | min |
| Tₘₐₓ | no curing | n.d. | 60.80° | C. | 124.34° | C. | 138.9° | C. |

*n.d. = not determined

### Results A3 and A4 for Shore a and Shore D Hardness

The epoxy resin compositions from Examples A3 and A4 were applied as a coating as described above and their Shore A and Shore D hardnesses were determined as described above. The test results in Table 5 show that the coating produced from the epoxy resin composition A4 after 4.5 h already had a higher Shore A hardness than the coating produced from the epoxy resin composition A3 after 6.5 h. The Shore D hardness reaches the same value at A3 and A4. Thus, the epoxy resin compositions are also suitable as a coating, wherein a higher proportion of copper (II) tetrafluoroborate hydrate leads more quickly to a harder coating.

TABLE 5
Shore A and Shore D hardness with a layer thickness
of 0.4 cm determined for Examples A3 and A4

| | A3 | A4 |
|---|---|---|
| Shore A hardness after 4.5 h at 25° C. | n.d.* | 54 |
| Shore A hardness after 6.5 h at 25° C. | 45 | 85 |
| Shore D hardness after 24 h at 25° C. | 70 | 70 |

*n.d. = not determined

The measured hardnesses are customary for coatings (customary coating Shore D hardnesses are typically between 50 and 100), which proves the suitability of the tested epoxy resin compositions for producing coatings.

### Results A2 and A4 for Pull-Out Tests

Components (A) and (B) of Example A2 were mixed as described above and tested with a pull-out test from wood as described above. In the pull-out test, a threaded rod M12 was used, wherein the borehole diameter was 14 mm and the embedding depth was 120 mm. The measured tensile force (in kN) was divided by the area of the borehole wall (in mm2) and thereby converted into a tensile resistance (in MPa). The tensile resistance calculated in this way is shown in Table 6.

TABLE 6
Pull-out tests from wood in Example A2

| Curing time at 25° C. [hours] | Tensile resistance [MPa] |
|---|---|
| 120 | 3.6 |
| 192 | 5.2 |

These results are acceptable tensile resistances for chemical anchors.

Components (A) and (B) of Example A2 were mixed as described above and tested with a pull-out test from concrete as described above. In the pull-out test, a threaded rod M12 was used, wherein the clamping depth was 60 mm. Even after 24 hours at 25° C., no curing was observed. This shows that the epoxy resin is not suitable for anchoring in concrete.

Components (A) and (B) of Example A4 were mixed as described above and tested with a pull-out test from brick as described above. Borehole diameter 16 mm, screen sleeve HIT-SC 16×85, threaded rod M10, embedding depth 80 mm.

After curing at 25° C. for 24 hours, the measured failure load was 19.1 kN. This failure load is of the order of magnitude as measured in commercially available chemical anchors.

### Examples B1-B3

The multi-component resin systems of the Examples B1-B3 according to Table 7 were tested.

TABLE 7
Examples B1-B3

| | | Examples (parts by | | |
|---|---|---|---|---|
| | | weight in wt. %) | | |
| Constituents | Function | B1 | B2 | 83 |
| Component (A) | | | | |
| Bisphenol F-based epoxy resin | Epoxy resin | 41.6 | 41.6 | 41.6 |
| Bisphenol A-based epoxy resin | Epoxy resin | 22.4 | 22.4 | 22.4 |
| 1,4-Butanediol diglycidyl | Reactive | 8.0 | 8.0 | 8.0 |
| ether | diluent | | | |
| Trimethylolpropane triglycidyl | Reactive | 8.0 | 8.0 | 8.0 |
| ether | diluent | | | |
| Quartz powder | Filler | 18.0 | 18.0 | 18.0 |
| Silica | Thickener | 2.0 | 2.0 | 2.0 |
| Component (B) | | | | |
| 1,2,3-propanetriol | Alcoholic | 55.8 | 55.8 | 55.8 |
| | curing agent | | | |
| Copper(II) tetrafluoroborate | Accelerator | 5.0 | 10.0 | 20.0 |
| hydrate | | | | |
| Quartz powder | Filler | 37.0 | 32.0 | 22.0 |
| Silica | Thickener | 2.2 | 2.2 | 22 |

EEW = 198 g/EQ (manufacturer specifications),
AHEW = 82 g/EQ (calculated as described above)

### Results B1-B3 for Tensile Shear Strength

Examples B1-3 were tested for their tensile shear strength as described above. The test results in Table 8 show that the tensile shear strength increases with a higher proportion of copper (II) tetrafluoroborate hydrate in component (B) and longer curing time.

TABLE 8
Tensile shear strength when used as an adhesive for B1-B3

| | B1 | | B2 | | B2 | | B3 | |
|---|---|---|---|---|---|---|---|---|
| Curing period | 2 | h | 1 | h | 2 | h | 1 | h |
| at 100° C. | | | | | | | | |
| Tensile shear | 1.5 | N/mm² | 1.0 | N/mm² | 2.7 | N/mm² | 2.7 | N/mm² |
| strength | | | | | | | | |

### Examples C1-C4

Table 9 shows compositions of components (A) and (B) of Examples C1-C4 which contain various alcohols in component (B). C1 contains only glycerol, and C2-C4 contain mixtures of other alcohols with glycerol.

TABLE 9
Examples C1-C4 with different alcohols

| | | Examples (parts by | | | |
|---|---|---|---|---|---|
| | | weight in wt. %) | | | |
| Constituents | Function | C1 | C2 | C3 | C4 |
| Component (A) | | | | | |
| Bisphenol A-based epoxy resin | Epoxy resin | 52 | 52 | 52 | 52 |
| Bisphenol F-based epoxy resin | Epoxy resin | 28 | 28 | 28 | 28 |
| 1,4-Butanediol diglycidyl ether | Reactive diluent | 10 | 10 | 10 | 10 |
| Trimethylolpropane triglycidyl ether | Reactive diluent | 10 | 10 | 10 | 10 |
| Component (B) | | | | | |
| 1,2,3-propanetriol | Alcoholic curing agent | 80 | 40 | 40 | 40 |
| 1,3-Benzenedimethanol | Alcoholic curing agent | | 40 | | |
| 2,6-Bis(hydroxymethyl)-p-cresol | Alcoholic curing agent | | | 40 | |
| 4,8-Bis(hydroxymethyl)tricyclo-[5.2.1.0 ^{2, 6}]decane | Alcoholic curing agent | | | | 40 |
| Copper(II) tetrafluoroborate hydrate | Accelerator | 20 | 20 | 20 | 20 |
| Stoichiometry A:B | | | | | |
| EEW [g/EQ] (manufacturer specifications) | | 158 | 158 | 158 | 158 |
| AHEW* [g/EQ] (calculated as described above) | | 58 | 69 | 74 | 78 |

For Examples C1-C4, the glass transition temperature was determined as described above. The test results in Table 10 show that the cured epoxy resin compositions have similar glass transition temperatures for Tg1 in the range of −17.5° C. to 9.5° C. and for Tg2 in the range of 30° C. to 59° C., and consequently these cured epoxy resin compositions are also suitable for use according to the invention.

TABLE 10
Glass transition temperatures of Examples C1-C4

| | C1 | C2 | C3 | C4 |
|---|---|---|---|---|
| Tg1 [° C.] | 9.5 | −17.5 | −1 | −12 |
| Tg2 [° C.] | 59 | 30 | 59 | 44 |

### Example D1

Analogously to Example A4, quartz powder was replaced by cement as filler in Example D1 in component (B).

TABLE 11
Example with cement as filler

| | | Example (parts by |
|---|---|---|
| | | weight in wt. %) |
| Constituents | Function | D1 |
| Component (A) | | |
| Bisphenol F-based epoxy resin | Epoxy resin | 58.0 |
| Quartz powder | Filler | 40.7 |
| Silica | Thickener | 1.3 |
| Component (B) | | |
| 1,2,3-propanetriol | Alcoholic curing | 63.0 |
| | agent | |
| Copper(II) tetrafluoroborate | Accelerator | 20.0 |
| hydrate | | |
| Cement | Filler | 14.6 |
| Silica | Thickener | 2.4 |

EEW = 290 g/EQ (manufacturer specifications),
AHEW = 73 g/EQ (calculated as described above)

Components (A) and (B) of Example D1 were mixed as described above. The test for curing was carried out here by stirring with a wooden spatula. The epoxy resin composition showed no observable curing at 25° C. within 24 h. i.e., it was very low-viscosity such as directly after mixing. This example shows that cement is unsuitable as a filler.

1. A multi-component resin system, comprising:
at least one resin component (A) comprising at least one curable epoxy resin; and
at least one curing agent component (B) comprising a curing agent for the at least one curable epoxy resin contained in the at least one resin component (A),
wherein the curing agent is at least one primary alcohol having a mean OH functionality of approximately 2 or higher;
further comprising:
copper (II) tetrafluoroborate in anhydrous form or as a hydrate.

2. The multi-component resin system according to claim 1, in a form of a two-component system.

3. The multi-component resin system according to claim 1, wherein the copper (II) tetrafluoroborate is contained only in component (B).

4. The multi-component resin system according to claim 3, wherein the copper (II) tetrafluoroborate is present with a molar fraction of approximately 0.1 to approximately 20 mol %, based on an amount of substance of the at least one alcohol in the component (B).

5. The multi-component resin system according to claim 1, wherein the at least one curable epoxy resin is a compound selected from the group consisting of glycidyl ethers of polyhydric phenols having an epoxide functionality of approximately 1.5 or greater and epoxidized vegetable oils, and mixtures thereof.

6. The multi-component resin system according to claim 1, wherein the at least one primary alcohol is a compound selected from the group consisting of 1,2,3-propanetriol (glycerol), 1,3-benzenedimethanol, 1,3-cyclohexanediol, 2,6-bis(hydroxymethyl)-p-cresol, 4,8-bis(hydroxymethyl)tricyclo[5.2.1.02.6]decane, 1,3-propanediol, 1,5-pentanediol and 1,4-butanediol, and mixtures thereof.

7. The multi-component resin system according to claim 1, additionally comprising at least one filler, wherein the at least one filler is contained either in the component (A) or in the component (B) or in both the components (A) and (B).

8. The multi-component resin system according to claim 7, wherein the at least one filler is a compound selected from the group consisting of oxides of silicon and aluminum, optionally with additional further cations.

9. The multi-component resin system according to claim 7, wherein the at least one filler is a non-basic filler.

10. An epoxy resin composition produced by mixing the at least one resin component (A) and the at least one curing agent component (B) of the multi-component resin system according to claim 1, wherein the mixing ratio of the at least one resin component (A) to the at least one curing agent component (B) is selected such that a stoichiometric ratio between reactive epoxide groups and primary alcohol groups is approximately 1:1.

11. A method, comprising:
employing the multi-component resin system according to claim 1 as an adhesive or as a coating.

12. A method, comprising:
employing the multi-component resin system according to claim 1 as chemical fastening of construction elements in boreholes or gaps.

13. The method according to claim 11, further comprising:
carrying out the method at a substrate temperature of from approximately −10° C. to approximately 180° C.

14. The method according to claim 11, further comprising:
carrying out the method on a non-basic substrate.

15. The method according to claim 13, wherein the substrate is at least one selected from the group consisting of: steel, wood, rock and brick.

16. A method, comprising:
employing the epoxy resin composition according to claim 10 as at least one selected from the group consisting of: an adhesive, a coating, and as chemical fastening of construction elements in boreholes or gaps.
